(19) United States
(12) Patent Application Publication
(10) Pub. No.: US 2011/0122034 A1
(43) Pub. Date: May 26, 2011

(54) BUILT-IN ANTENNA FOR HEADSET

(76) Inventor: Byong-Nam Kim, Kyeonggi-do (KR)

(21) Appl. No.: 13/054,650

(22) PCT Filed: Jan. 30, 2009
(86) PCT No.: PCT/KR2009/000464

§ 371 Date: Jan. 18, 2011

(30) Foreign Application Priority Data
Jul. 18, 2008 (KR) 10-2008-0069906

(51) Int. Cl. H01Q 1/22

(52) U.S. Cl. 343/718

(57) ABSTRACT

Disclosed is an internal antenna for a headset. The disclosed antenna comprises: a substrate, which is included inside a headset body; a feeding pattern formed on the substrate; a connecting part, which is made of a metallic material and electrically connected to the feeding pattern, and a portion of which protrudes into the housing of the headset body; a hooking part, which is joined with the connecting part; and a radiator, which is inserted into the hooking part. According to an embodiment of the present invention, audio signals may be sent and received with higher efficiency, without using a chip antenna, and the antenna may be less affected by such external factors as the hand effect and head effect.

### TECHNICAL FIELD

The present invention relates to an antenna, more particularly to an antenna mounted inside a headset such as a Bluetooth headset device.

### BACKGROUND ART

In recent times, wireless headsets have been in widespread use, appended to portable terminals such as mobile phones and MP3 players. Since wireless headsets exchange signals with such portable terminals as mobile phones and mp3 players, providing for their users the convenience of using such terminals without having to hold them directly in their hands, the use of wireless headsets is expected to continue to increase.

Such wireless headsets mainly use the Bluetooth system, which is a representative communication system for local area networks in recent times, while communication can also be implemented through the DECT, binary CDMA systems.

A wireless headset comprises: a headset body, which includes an antenna and a wireless chip, such as a Bluetooth chip, for wireless sending and receiving of audio signals in a local area, as well as a circuit for frequency modulation and for amplifying audio signals; a switch for controlling power supply and operation; an earphone for outputting audio signals; and a hooking part for securing the headset to the user's ear.

According to the related art, the chip antenna was mainly in use for an internal antenna for a wireless headset. As the chip antenna can be produced in quite a small size, in terms of size it was suitable for wireless headsets, which are small devices.

However, the chip antenna has a low efficiency of about −7 dB to −8 dB, and has the problem of causing the sound quality of audio signals to change abruptly if it is touched or moved by a hand.

In recent times, there has been an increasing demand for high sound quality for headsets, and such a demand could not be satisfied by the chip antenna, due to its low efficiency and abruptly changing receive sensitivity.

### DISCLOSURE

### Technical Problem

In order to solve the aforementioned problems of the related art, the present invention proposes an internal antenna for a wireless headset, which can receive audio signals in a stable manner.

Another purpose of the present invention is to propose an antenna which can be built into a wireless headset with higher efficiency, rather than using a chip antenna.

Yet another purpose of the present invention is to propose an internal antenna for a wireless headset, which is influenced less by external factors such as the hand effect or head effect.

Other purposes of the present invention may be drawn by those skilled in the art from the embodiments below.

### Technical Solution

In order to fulfill the aforementioned purposes, an aspect of the present invention provides an internal antenna for a headset that includes: a substrate, which is included inside a headset body; a feeding pattern formed on the substrate; a connecting part, which is made of a metallic material and electrically connected to the feeding pattern, and a portion of which protrudes into the housing of the headset body; a hooking part, which is joined with the connecting part; and a radiator, which is inserted into the hooking part.

The connecting part is rotatably installed on the substrate.

The connecting part has a groove for joining the hooking part, and the radiator, inserted into the hooking part, is fed RF signals by coupling.

The radiator is implemented by a metal wire or a FPCB.

The radiator is inserted into the hooking part in the area where the connecting part and the hooking part are joined.

Another aspect of the present invention provides an internal antenna for a headset that includes: a substrate, which is included inside a headset body; a feeding pattern formed on the substrate; a feeding part made of a metallic material and electrically connected to the feeding pattern; a rotational shaft, which extends from the feeding part and is rotatably installed; a connecting part, which is joined with the rotational shaft and placed at a particular distance away from the feeding part, and a portion of which protrudes into the housing of the headset body; a hooking part joined with the connecting part; and a radiator inserted into the hooking part.

The rotational shaft is made of a dielectric material.

The feeding part feeds RF signals to the connecting part by coupling.

The connecting part has a groove for joining the hooking part, and the radiator, inserted into the hooking part, is fed RF signals by coupling.

### Advantageous Effects

According to an embodiment of the present invention, audio signals may be sent and received with higher efficiency, without using a chip antenna, and the antenna may be less affected by such external factors as the hand effect and head effect.

### DESCRIPTION OF DRAWINGS

FIG. 1 is a perspective view of an internal antenna for a wireless headset according to a first embodiment of the present invention.

FIG. 2 is a cross-sectional view of an internal antenna for a wireless headset according to the first embodiment of the present invention.

FIG. 3 is a perspective view illustrating the structure of an internal antenna for a wireless headset according to a second embodiment of the present invention.

FIG. 4 is a cross-sectional view of an internal antenna for a wireless headset according to the second embodiment of the present invention.

FIG. 5 is a drawing illustrating an example of a headset to which an internal antenna for a headset according to the present invention can be applied.

### MODE FOR INVENTION

The internal antenna for a headset according to certain embodiments of the invention will be described below in more detail with reference to the accompanying drawings.

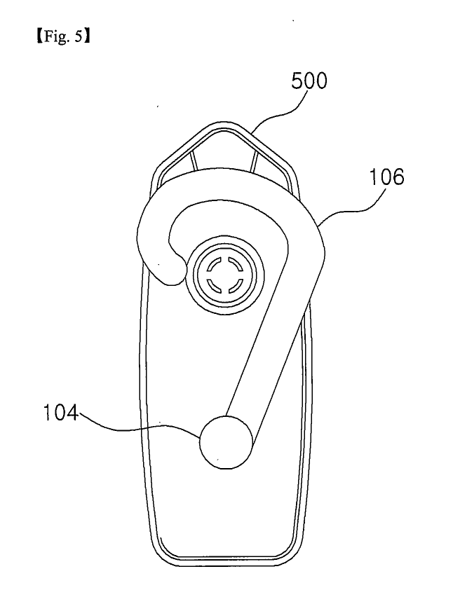

FIG. 5 is a drawing illustrating an example of a headset to which an internal antenna for a headset according to the present invention can be applied.

With reference to FIG. 5, a headset to which the present invention is applied comprises a headset body 500, and a hooking part 106 for wearing the headset body on a user's ear or head. The hooking part 106 is connected to the headset body by a connecting part 104, where the connecting part 104 can be installed rotatably or fixedly.

If the connecting part 104 is rotatably installed, as illustrated in FIG. 5, it can be implemented as a cylindrical shape protruding from the housing body 500.

The inside of the headset body 500 is equipped with a substrate, and on the substrate is installed a wireless chip, such as a Bluetooth chip, and a circuit for modulation, amplification, etc.

The hooking part 106 can also be set to rotate 360 degrees on its own, and not just in conjunction with the rotation of the connecting part 104.

Below, an internal antenna for a wireless headset which can be applied to a variety of wireless headset devices, such as exemplified in FIG. 5, will be described in more detail.

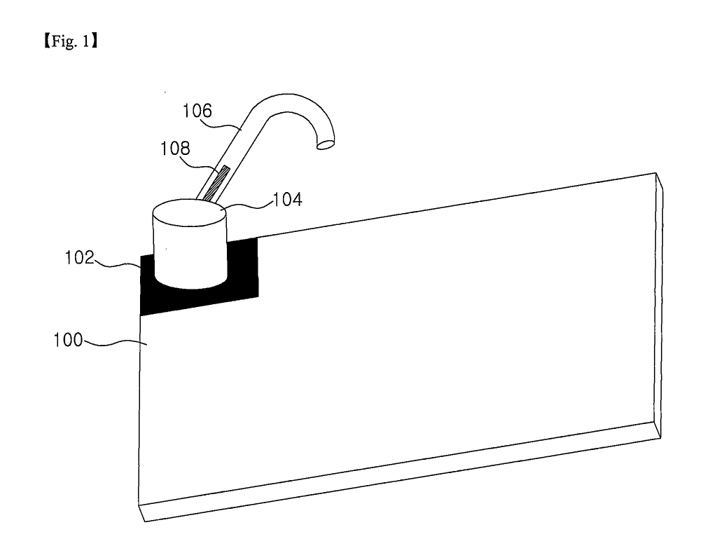

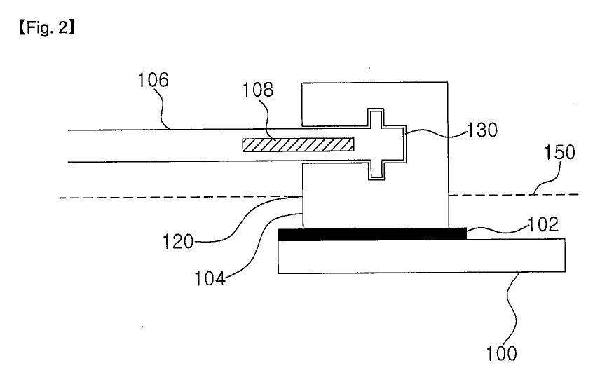

FIG. 1 is a perspective view of an internal antenna for a wireless headset according to a first embodiment of the present invention, and FIG. 2 is a cross-sectional view of an internal antenna for a wireless headset according to the first embodiment of the present invention.

With reference to FIG. 1, an internal antenna for a wireless headset according to an embodiment of the present invention may comprise: a substrate 100; a feeding pattern formed on the substrate 102; a connecting part 104 electrically connected to the feeding pattern 102; a hooking part 106 joined with an upper end of the connecting part 104; and a radiator 108 inserted into the hooking part 106.

For the sake of ease of explanation, the headset body housing is not illustrated in FIG. 1, and an example will be illustrated in which an upper part of the connecting part 104 protrudes out of the housing, and the hooking part 106 is joined with the connecting part 104 on the protruding part of the connecting part 104.

So as to be able to change the position of the hooking part 106 for securely wearing the headset on an ear or head, the connecting part 104 may preferably be set to rotate, but the present invention is not thus limited.

In an embodiment of the present invention, an antenna is proposed wherein a monopole radiator is inserted into the hooking part, so that Bluetooth signals are sent and received by a monopole antenna, as opposed to a chip antenna.

The substrate 100 is built in inside the wireless headset body, and on the substrate 100 are formed a chip for processing signals, such as Bluetooth signals, and a circuit for modulation, amplification, etc. For the substrate 100, various forms of substrate may be used, such as a PCB, FR4, etc.

A feeding pattern 102 is formed on the substrate 100, and RF signals as provided by a wireless chip like a Bluetooth chip are provided through the feeding pattern 102.

The connecting part 104 is set on the substrate 100, and is electrically joined with the feeding pattern 102 on the substrate.

As described above, the connecting part 104 may be set on the substrate so as to rotate by way of a variety of mechanical structures, and as these are of common knowledge to those skilled in the art, a detailed explanation of these structures will be omitted.

An upper part of the connecting part 104 protrudes out of the Bluetooth headset body housing 150 (the housing is not shown in FIG. 1), and a through-hole 120 is formed in the housing, out of which the connecting part 104 protrudes.

According to the related art, the connecting part 104 is generally made of a dielectric material such as plastic. According to an embodiment of the present invention, however, the connecting part 104 is implemented by a metallic material, so as to provide RF signals from the feeding pattern 102 to the radiator 108.

The connecting part 104 has a joining groove 130 for joining it with a hooking part 106. The hooking part 106 is mechanically joined with the connecting part 104 by way of the joining groove 130, and if the connecting part 104 is able to rotate, it rotates in correspondence with the rotation of the connecting part 104. Of course, the hooking part 106 may be joined with the connecting part 104 by various means other than that illustrated in FIGS. 1 and 2.

The hooking part 106 may be implemented by a ductile dielectric material such as rubber, silicone, etc., and a radiator 108 of a prescribed length may be inserted into the connecting part 106, while the position of insertion may preferably be in the area where the connecting part 104 and the hooking part 106 are joined.

The radiator 108 may be a metallic wire or may be implemented by a FPCB, and may be of a variety of metallic material. The radiator, which is inserted into the hooking part 104, receives feed by way of coupling, and coupling takes place from the connecting part 104, which is made of metal.

According to an embodiment of the present invention, the radiator 108 may be inserted into the hooking part by way of insert molding, but it is not limited to this option.

RF signals applied to the feeding pattern 102 are fed to the radiator 108 electrically joined with the feeding pattern 102 by way of coupling through the metallic connecting part 104, and the radiator 108 radiates coupling-fed signals or receives RF signals transmitted from the outside by way of a monopole structure.

The length of the radiator 108 is determined by the frequency band used, and may be about 24 mm in length in the case of a Bluetooth band.

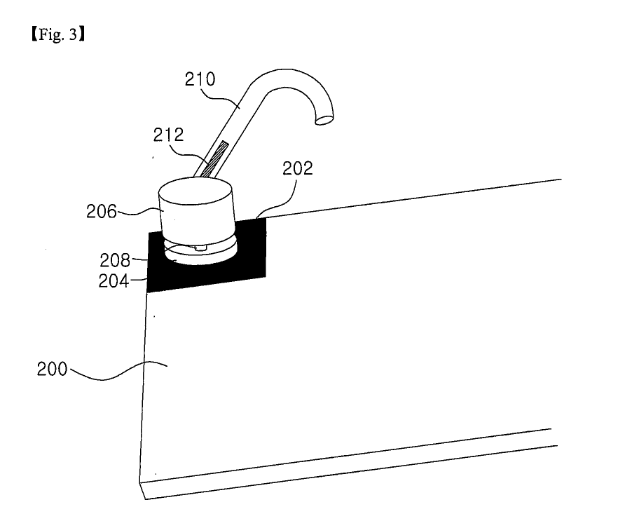

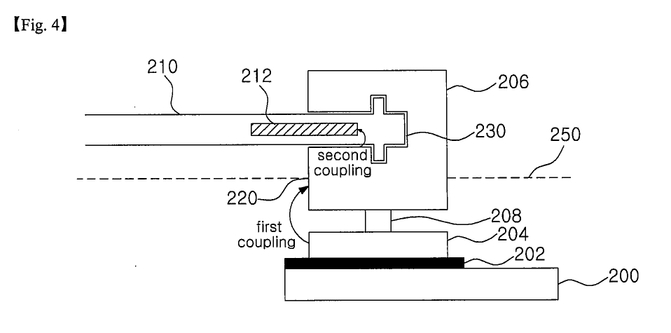

FIG. 3 is a perspective view illustrating the structure of an internal antenna for a wireless headset according to a second embodiment of the present invention, and FIG. 4 is a cross-sectional view of an internal antenna for a wireless headset according to the second embodiment of the present invention.

With reference to FIG. 3, an internal antenna for a wireless headset according to an embodiment may comprise: a substrate 200; a feeding pattern formed on the substrate 202; a feeding part 204 electrically connected to the feeding pattern; a connecting part 206 placed at a particular distance away from the feeding part 204; a rotational shaft 208 which is rotatably installed and which separates the connecting part 206 and the feeding part 204 by a particular distance; a hooking part 210 joined with an upper end of the connecting part 206; and a radiator 212 inserted into the hooking part.

In the embodiment illustrated in FIGS. 1 and 2, the connecting part 104 rotates while keeping electrical contact with the feeding pattern 102. Here, the electrical contact with the feeding pattern 102 may be destabilized by the rotation of the connecting part. The second embodiment illustrated in FIGS. 3 and 4 is an embodiment that improves on such instability of the electrical contact.

In FIGS. 3 and 4, the cylindrical feeding part 204 is electrically joined with the feeding pattern 102. The feeding part 204 is made of a metallic material. The feeding part 204 is set fixedly, not to rotate, and maintains electrical contact with the feeding pattern 202.

The rotational shaft 208 protrudes out of the upper part of the feeding part 204, to be mechanically joined with the connecting part 206.

As described above, the connecting part 206 is joined with the rotational shaft 208 at a particular distance away from the feeding part 204, and rotates if an external force is applied. The upper part of the connecting part 208 protrudes out of the Bluetooth headset body housing 250 (the housing not pictured in FIG. 3), and the housing has a through-hole 220, out of which the connecting part 206 protrudes.

The connecting part of the second embodiment is also made of a metallic material. Feeding of RF signals to the connecting part 206 is done by a first coupling. The connecting part 204, electrically joined with the feeding pattern 202, feeds RF signals to the connecting part 206 by way of the first coupling.

As in the first embodiment, the connecting part 206 has a joining groove 230 for joining the hooking part 210 to it, and the hooking part 210 is mechanically joined with the connecting part 206 by way of the joining groove 230. As described above, the hooking part 210 may be joined with the connecting part by a variety of joining methods, besides the joining groove method.

The radiator is inserted into the hooking part 210, and as described above, the radiator 212 may be inserted into the hooking part 210 by way of insert molding, for example.

The radiator, as in the first embodiment, may preferably be inserted in the area where the hooking part 210 and the connecting part 208 are joined.

Feeding from the connecting part 208 to the radiator 212 is done by a second coupling, and the radiator 212 radiates the RF signals fed or receives the RF signals transmitted from the outside.

While the present invention has been described with reference to particular embodiments, it is to be appreciated that various changes and modifications may be made by those skilled in the art without departing from the spirit and scope of the present invention, as defined by the appended claims and their equivalents.

1. An internal antenna for a headset, the antenna comprising:
a substrate included inside a headset body;
a feeding pattern formed on the substrate;
a connecting part made of a metallic material and electrically connected to the feeding pattern, the connecting part having a portion thereof protruding into a housing of the headset body;
a hooking part joined to the connecting part; and
a radiator inserted into the hooking part.

2. The internal antenna for a headset according to claim 1, wherein the connecting part is rotatably installed on the substrate.

3. The internal antenna for a headset according to claim 2, wherein the connecting part has a groove formed therein for joining the hooking part, and RF signals are fed to the radiator inserted into the hooking part by way of coupling.

4. The internal antenna for a headset according to claim 2, wherein the radiator is implemented by a metal wire or a FPCB.

5. The internal antenna for a headset according to claim 2, wherein the radiator is inserted into the hooking part in an area where the connecting part and the hooking part are joined.

6. An internal antenna for a headset, the antenna comprising:
a substrate, included inside a headset body;
a feeding pattern formed on the substrate;
a feeding part made of a metallic material and electrically joined with the feeding pattern;
a rotational shaft extending from the feeding part and rotatably installed;
a connecting part joined with the rotational shaft and placed at a particular distance away from the feeding part, the connecting part having a portion thereof protruding into a housing of the headset body;
a hooking part joined with the connecting part; and
a radiator inserted into the hooking part.

7. The internal antenna for a headset according to claim 6, wherein the rotational shaft is made of a dielectric material.

8. The internal antenna for a headset according to claim 7, wherein the feeding part feeds RF signals to the connecting part by way of coupling.

9. The internal antenna for a headset according to claim 7, wherein the connecting part has a groove formed therein for joining the hooking part, and RF signals are fed to the radiator inserted into the hooking part by way of coupling.

10. The internal antenna for a headset according to claim 9, wherein the radiator is inserted into the hooking part in an area where the connecting part and the hooking part are joined.
